(19) United States
(12) Patent Application Publication
(10) Pub. No.: US 2002/0087969 A1
(43) Pub. Date: Jul. 4, 2002

(54) Interactive TV audience estimation and program rating in real-time using multi level tracking methods, systems and program products

(75) Inventors: Jose Brunheroto, Mohegan Lake, NY (US); Richard S. Chernock, Newtown, CT (US); Paolo Dettori, Elmsford, NY (US); James S. Lipscomb, Yorktown Heights, NY (US); Lurng-Kuo Liu, White Plains, NY (US); Julio Nogima, White Plains, NY (US); Frank A. Schaffa, Hartsdale, NY (US); David I. Seidman, Chicago, IL (US); Liang-Jie Zhang, White Plains, NY (US)

Correspondence Address: Joseph C. Redmond, Jr., Morgan & Finnegan, L.L.P., 345 Park Avenue, New York, NY, 10154-0053, US

(73) Assignee: International Business Machines Corporation, Armonk, NY (US)

(21) Appl. No.: 09/749,670

(22) Filed: Dec. 28, 2000

(51) Int. Cl. H04N 7/173; H04N 7/16; H04H 9/00

(52) U.S. Cl. 725/13; 725/113

(57) ABSTRACT

An interactive TV content creation tool imports video and other assets, including WebPages, Java script, etc., as a series of resources for interactive TV content creation for real time audience estimation and program ratings. A processing system embeds hyperlinks into one or more objects contained in a program frame as desired. Each hotlink has attributes. These attributes include shape, name, description and Z-order. The hotlink can have one of several shapes, including rectangle, ellipse and parallelogram. The hotlink types are included in an object tree which is displayed in a window to a creator. A hotlink type is selected in the hotlink tree, and a window displays a linked properties tab available for the selected object. There are several link types available; linking to a URL, another interactive TV content file, a video clip, an audio clip, an image, or a tracking action and transaction action. There are different parameters for different actions. One parameter is a tracking script. Another parameter is a tracking flag. The tracking flag can be set to follow different tracking modes. If the “enable global tracking” is chosen, a name/value pair “global=true” will be appended to the tracking script transmitted to the global tracking server through network. If the “enable local tracking” is chosen, a name/value pair “local=true” will be appended to the tracking script. The embedded tracking information can follow three multi-level tracking patterns (MTP): regular program viewing tracking, enhanced program viewing tracking, and per object granularity tracking. The viewer returns the script to a server which calculates audience estimation and program ratings for the interactive TV program.

### RELATED APPLICATIONS

(1) PCT Published Application WO/98/44435 entitled “Method and Apparatus for Integrating Hyperlinks in Video”, by Jeane Chen, Ephraim Feig, Liang-Jie Zhang, published Oct. 8, 1998.

(2) “Method and Apparatus for Integrating Hyperlinks in Video” (Y0997-087), by Jeane Chen, Ephraim Feig, Liang-Jie Zhang”, Ser. No. ______, filed ______.

(3) “Method and Apparatus for Content Association Broadcast Data Sources in Enhanced TV “(SOM8-2000-00030), by James S. Lipscomb, Lurmg-Kuo Liu, and Liang-Jie Zhang, Ser. Number ______, filed ______.

(4) Co-Pending application entitled “Interactive TV Contextual Content Surfing Using Inter-channel Hyperlinking: Systems, Methods & Program Products” (SOM9-2000-00013), by James S. Lipscomb, Lurng-Kuo Liu, and Liang-Jie Zhang, Ser. No. ______, filed Dec. 28, 2000.

The above-related applications are all assigned to the same assignee as that of the present invention and are fully incorporated herein by reference.

### BACKGROUND OF INVENTION

1. Field of Invention

This invention relates to Television broadcasting systems, methods and program products. More particularly, the invention relates to interactive TV audience estimation and program rating including program objects, in Real-time, using multi level tracking methods, systems and program products.

2. Description of Prior Art

Interactive TV converges the Internet and television so you can participate in new ways with your favorite shows. The ratings provide an estimate of audience size and composition for television programmers and commercial advertisers, and are a barometer of people's viewing habits. Customers use the television audience research report to buy and sell television time as well as to make program decisions. With the advent of digital television, TV program viewing can be tracked and analyzed and an opportunity is available to build new targeting systems which go a stage beyond today's random sampling tools. Today, almost every broadcasting station and audience rating agency regularly takes surveys of audiences to determine ratings of specified TV channels during specific time periods.

A known technique for getting the estimates of audience to determine ratings involves telephoning a limited random sample of homes and asking which channel is currently being viewed. This technique could alter their viewing behavior and bias the sample. Such survey technique may be relatively inaccurate due to insincere answers to inquiries, and time intervals between the surveys may be restricted. Another electronic measurement used by Nielsen Media Research is Nielsen People Meter. The meters are placed in a sample of 5,000 households (13,000 persons) in the U.S., randomly selected and recruited by Nielsen Media. The People Meter is placed on each TV in the sample household. The meter measures two things-what program or channel is being tuned and who is watching. The People Meter is used to collect audience estimates for broadcast and cable networks, nationally distributed syndicated programs and satellite distributors. Both are random survey systems that require a lot of money and time.

What is needed in the art is enabling broadcasting station or rating agency to automatically perform tracking functions in real time, which is based on the viewer's action as well as the content of audiovisual programming being shown to the user at the same time, using a per-object-granularity tracking mechanism for the content.

But how to exactly know their favorite shows rank in the rating and audience estimates is an emerging task. U.S. Pat. No. 6,061,082 titled “System and Method for Tracking a Survey of an Audience to Determine a Rating using Internet Television”, issued May 9, 2000 invented an interactive TV system for automatically taking a survey of an audience to determine a rating of specified TV channels and during specified time periods. The broadcasting station encodes the viewing channel search command into a TV broadcasting signal and broadcasts the TV broadcasting signal. The Internet TV receivers decode the TV broadcasting signal received from the broadcasting station. If the decoded TV broadcasting signal includes the viewing channel search command, the Internet TV receivers write electronic mails including currently viewed channels, and transmit the electronic mails to the broadcasting station. Then, the broadcasting station determines the audience rating based on the electronic mails received from the Internet TV receivers. Obviously, the system has the following disadvantages:

1. Real-time rating results are difficult to obtain from the '082 system. After receiving the emails from the Internet TV clients, the system needs another application to process/analyze the emails so as to get the final rating results. Moreover, the email protocol cannot guarantee on-time delivery.

2. The '082 system has a lack of the capability to track the viewing experience of interactive TV program. In current interactive TV programs, the video is the same no matter if you choose enhanced viewing experience mode to watch the video and data (e.g. Web pages). For example, if a user is watching a TV program with video content plus web page on the same TV screen, the '082 system cannot determine if the enhanced mode is used. Let alone, the system cannot determine which product's information page has been viewed by the TV user.

3. The '082 system is a time based surveying mechanism. That is, at a certain time point, when the client receives the broadcasting signal including the viewing channel search command, the '082 system will automatically send back email to the broadcasting station or an agency, no matter what's the real interesting points in the current viewing program. In other words, there is no relationship between the broadcasting audiovisual content itself and the search command in the broadcasting signal. For example, if there are two actors or objects on the same TV screen, the '082 system doesn't care who is the favorite actor or object of the current program viewer, although the TV user has chosen to watch the detailed information by clicking an actor's hyperlink in the video stream.

Other prior art related to audience measuring systems includes: U.S. Pat. No. 6,061,082, issued May 9, 2000 discloses an Internet TV system for automatically taking a survey of an audience to determine a rating of specified TV channels and during specified time periods. The Internet TV system includes a broadcasting station and at least two Internet TV receivers. The broadcasting station encodes a viewing channel search command into a TV broadcasting signal and broadcasts the TV broadcasting signal. The Internet TV receivers decode the TV broadcasting signal received from the broadcasting station. If the decoded TV broadcasting signal includes the viewing channel search command, the Internet TV receivers write electronic mails including currently viewed channels, and transmit the electronic mails to the broadcasting station. Then, the broadcasting station determines the audience rating based on the electronic mails received from the Internet TV receivers.

U.S. Pat. No. 5,442,456, issued Aug. 15, 1995 discloses an apparatus for generation of multi-level navigable video environments is disclosed. Generation of the virtual realities is accomplished by a video monitor, a touch screen, a CPU, and a compact disc storage device. The storage device contains pre-generated audio and visual data. The visual data includes a plurality of digitized photographic images stored as a plurality of frames of a visual track. The frames may be selectively accessed by a user through the touch screen to provide the user the ability to navigate through a navigable video environment. Further, while the user is within the navigable video environment, a second level of a navigable video environment is accessible. The data for generation of the second-level of video environment is also stored within the storage device and is also pre-generated

U.S. Pat. No. 5, 918,012, issued Jun. 29, 1999 discloses a network data processing system is disclosed that uses novel methods and apparatus to hyperlink from full motion videos. The present invention can be used with any standard video file by adding a header identifying a video map location and a script location identifying where the hyperlinks are associated with the video file for any given frame. The present invention includes a new viewer that reads the header and issues the header information, X-coordinate, Y-coordinate, and time coordinate for a particular hyperlink selection made by a user via a computer-pointing device. An HTTP Server and video script then operate in conjunction to obtain the corresponding map and identify a network address associated with the coordinate information provided by the viewer.

U.S. Pat. No. 6,078,951 issued Jun. 20, 2000 discloses a network data processing system is disclosed that uses novel methods and apparatus to hyperlink from full motion videos. The present invention can be used with any standard video file by adding a header identifying a video map location and a script location identifying where the hyperlinks are associated with the video file for any given frame. The present invention includes a new viewer that reads the header and issues the header information, X-coordinate, Y-coordinate, and time coordinate for a particular hyperlink selection made by a user via a computer-pointing device. An HTTP Server and video script then operate in conjunction to obtain the corresponding map and identify a network address associated with the coordinate information provided by the viewer.

U.S. Pat. No. 6, 070,185, issued May 30, 2000 discloses a communications arrangement, in which a computer user accesses a server system to seek customer service over the World Wide Web (WWW). The server system assigns a customer service agent (CSA) to communicate with the user to realize the customer service. In a customer service session, the user and CSA may collaboratively browse hypertext markup language (HTML) documents at different uniform resource locators (URLs) to obtain relevant information. However, in accordance with the invention, the version of each document presented to the user may be different from that presented to the CSA. In particular, the CSA version contains proprietary information which is excluded from the user version. one of the prior art discloses creating interactive TV program and a series of frames incorporating images as objects in the frames.

None of the prior art discloses embedding hyperlinks into video programs including objects in the program content for distribution to viewers and a server with multi level tracking mechanisms to obtain real time audience estimation and program ratings including program content and objects.

### SUMMARY OF THE INVENTION

An object of the invention is methods, systems and program products for real time interactive TV audience estimation and program rating.

Another object is embedding hyperlinks in program content including program objects, e.g. scenery, actors, etc.

Another object is assigning linking properties to hyperlinks for program tracking scripts.

Another object is providing multi-level tracking patterns for hyperlink(s) in an interactive TV program.

Another object is transmitting interactive TV programs with hyperlinks and tracking information to viewers for real time audience estimation and program ratings including program content and program objects.

These and other objects, features and advantages are achieved in an interactive TV broadcast system including a content creation tool which imbeds hyperlinks into video programs for TV audience estimation and program ratings using multi-level tracking mechanisms. The interactive TV content creation tool imports video and other assets, including WebPages, Java script, etc., in frames, as a series of resources for interactive TV content creation. A processing system embeds hyperlinks or hotlinks into one or more objects, e.g. actor(s), scenery, etc., contained into a program frame, as desired. Each hotlink has attributes. The attributes include shape, name, description and Z-order. The hotlink can have one of several shapes, including rectangle, ellipse and parallelogram. The hotlink types are included in a tree which is displayed in a window to the creator. A hotlink type is selected in the tree. A window displays a linked properties tab available for the selected object. There are several link types available; linking to a URL, another interactive TV content file, a video clip, an audio clip, an image, or a tracking action and transaction action. There are different parameters for different actions. One parameter is a tracking script. Another parameter is a tracking flag. The tracking flag can be set to follow different tracking modes. If the “enable global tracking” is chosen, a name/value pair “global=true” will be appended to the tracking script transmitted to the global tracking server through network. The global tracking parameter will be used for collecting information on the viewer's actions. If the “enable local tracking” is chosen, a name/value pair “local=true” will be appended to the tracking script. The embedded tracking information can follow three multi-level tracking patterns (MTP): regular program viewing tracking, enhanced program viewing tracking, and per object granularity tracking. In operation, a tracking server handles data collecting, analyzing, and database management of tracking scripts transmitted by viewers. The viewer receiver ID is automatically appended to the tracking script by the viewer receiver. The tracking server will capture the tracking script including the receiver ID and other tracking information. The tracking server will determine how many receivers viewed the channel and the objects which were viewed. From this information, the server can indicate the TV audience estimation, program rating, and interest and objects contained in video frames on a real-time basis based on the hyperlinked activity which is concurrent with viewer interests and the video presentation. The server generates a real-time tracking report which indicates the interest of the viewers in any one of the three tracking patterns, based upon the viewer selection of the hyperlinks.

### DESCRIPTION OF THE DRAWINGS

The invention will be further understood from the following detailed description of a preferred embodiment taken in conjunction with an appended drawing, in which:

FIG. 1 is a representation of an interactive TV tracking system incorporating the principles of the present invention.

FIG. 2 is a representation of an interactive TV content creation process employed in the system of FIG. 1.

FIG. 3 is a representation of tracking information delivery in a receiver included in the system of FIG. 1.

FIG. 4 is a representation of an interactive TV tracking report generated by the tracking server in the system of FIG. 1.

### DESCRIPTION OF PREFERRED EMBODIMENT

The following are the design goals for the TV audience estimates and program rating of the present invention using a per-object-granularity tracking mechanism:

1. Propose three multilevel tracking patterns (MTP): (a) regular program viewing tracking—a TV viewer's viewing mode: only the regular audiovisual program with visible or invisible interactive icon on the video program is on the TV screen, (b) enhanced program viewing—a TV viewer's mode: the regular audiovisual program plus the enhanced interactive content around the audiovisual program are on the same TV screen and per-object-granularity tracking—a TV viewer's mode: all the hyperlinked objects in the audiovisual program can be clicked by the remote control or mouse.

2. Define a tracking delivery framework that expands the scope of information

3. For every content context, enable the individual specification and customization

4. Enable seamless interfacing with multiple local tracking servers requiring.

5. Enable specification of tracking disablement for the broadcasting content.

6. Use an existing and widely used protocol as a TV real-time Tracking. an example, HTTP is one of the existing protocols that can be used on today's network.

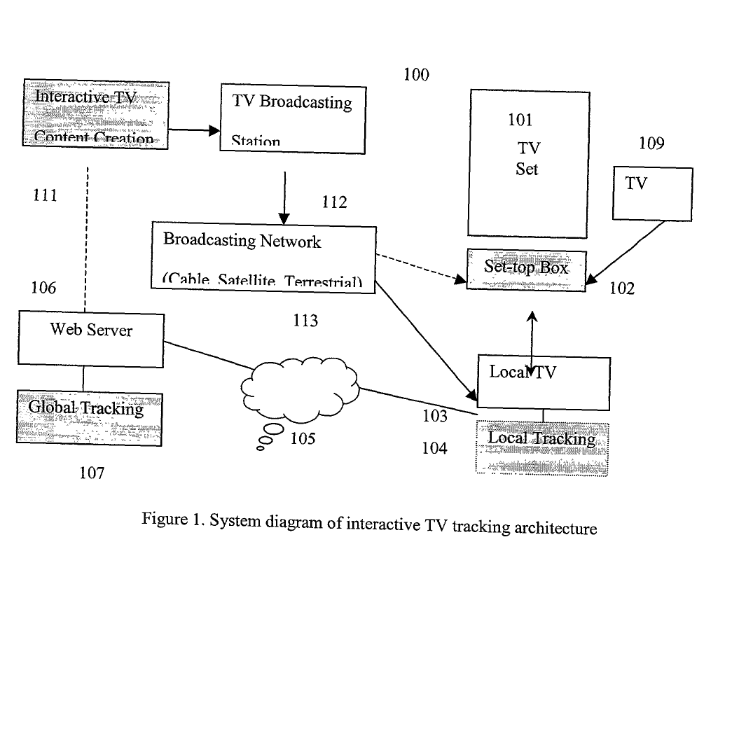

FIG. 1 describes an interactive TV tracking architecture 100 including a TV set 101 linked to a set-top box 102 and achieving the foregoing design objectives. A local TV station 103 is coupled to the set-top box for display of a TV program for the TV viewer 109. A local tracking unit 104 is linked to the local station 103 and coupled via a network, typically the Internet to a Web server 106. A global tracking unit 107 is linked to the Web server. An interactive TV content creation station 111 is linked to the server and coupled to a TV broadcasting station 112. A broadcasting network 113 is coupled to the local TV station and linked to the set top box 102. A customized tracking capability is implemented in the system 100 and meets the design goals as will be described hereinafter.

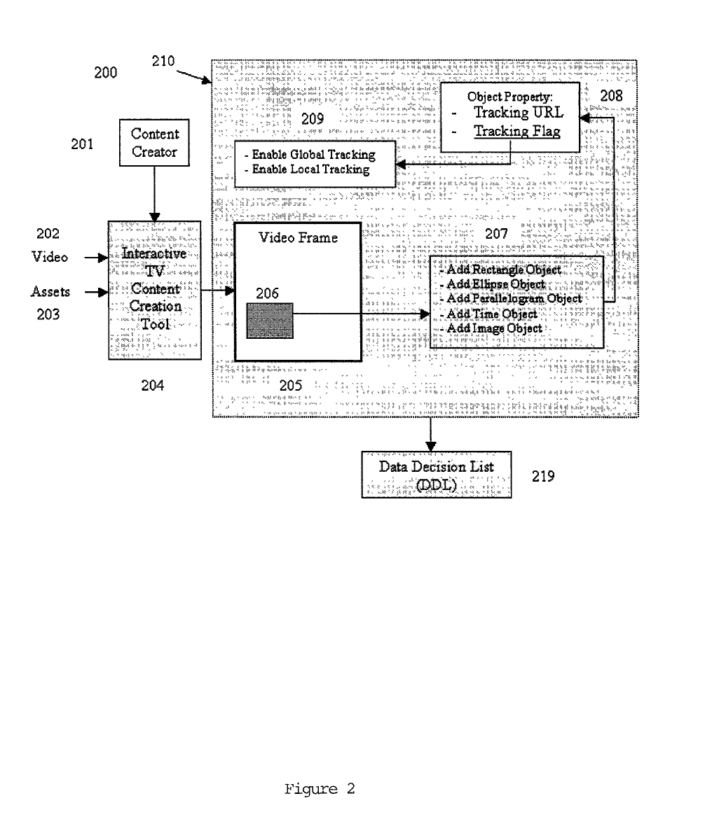

FIG. 2 describes an interactive TV content (iTV) creation process 200 for audience estimation and program ratings. In the content creation stage, using an interactive TV content creation tool, e.g. IBM Hot Video Authoring Tool, described in the related application entitled “Method and Apparatus for Integrating Hyperlinks” in Video” (Y0997-087), by Jeane Chen, Ephraim Feig, Liang-Jie Zhang), supra, hyperlinks can be embedded into video programs in two different ways: time based presentation links and object based hotlinked video. Including tracking information into the time based presentation links provides accurate tracking for the program ratings. The hotlinked video hyperlinks are directly related to the video objects, e.g. actors, etc in the video program for per-object-granularity tracking information and embedded into TV program by using the hotlinked video technology included in the content creation tool previously described. Moreover, for every content context, the content creation tool enables the individual specification and customizability of information to be efficiently tracked at the time of content creation.

A TV tracking protocol (TVTP) can be easily embedded into a digital TV stream, such as MPEG-2 Transport Stream or analog TV stream such as Vertical Blanking Interval (VBI). In a preferred embodiment, the HTTP protocol can be used to transmit tracking information for the regular set-top box with HTML support.

Continuing in FIG. 2, the content creator 201 makes use of the interactive TV content creation tool 204 to import resources such as video 202 and other assets 203 including web pages, JavaScript, Enterprise Java Beans (EJBs), URLs, Images and E-Commerce Store with product catalogs as an interactive TV program. The tool extends the concept of hyperlinks from text and image to dynamic objects in videos. With the Hot Video Authoring Tool, a digital video can be linked to various types of media—web pages, videos, audio, images, or other TV files. The tool provides friendly user interfaces and powerful functionality. Hotspots are linked to objects that are inserted onto the video. The object hotspot indicates the position and shape of the object in the current frame. A TV object 206 is normally associated with a meaningful object in the video 205, such as a person or a tree. However, an inserted object can either be visible or invisible to viewers, depending on specific application requirements. If an inserted object is designed to be visible to the viewers, the object is represented by a movable hotspot with or without special effect during playback. An object contains one or more actions which can be activated by clicking on the hotspot or by a certain time (also called Time Driven). If an object only contains time driven actions, it can do so without any hotspot. Each TV object has attributes. These attributes include Shape, Name, Description, and Z-Order (the order in which the objects are placed on each other in the direction going into the screen). An object can have one of the following shapes: Rectangle, Ellipse and Parallelogram. Those hotlinked object types have been included in an object tree 207. When an action is selected in the object tree 207, a window displays a link properties tab 208 in a drop down list. The link type is selected in the drop down list. There are several types available: (a) linking to a URL, (b) another interactive TV content file, (c) a video clip, (d) an audio clip, (e) an image, or (d) a tracking action and (e) a transaction action. There are different parameters for different actions. For example, for the tracking properties 208, there are two properties. One property is the Tracking URL, including a tracking script sent to each set-top box. The other property is a Tracking Flag sent to each set-top box. The widely used HTTP serves as a TV Tracking Protocol (TVTP).

The Tracking script embodiment (1) has the following style:

http://tracking.server.name/trackingScript?

param1=value1 &param2=value2&destination=targetURL

Where:

(a) http://is used as a TV tracking protocol;

(b) tracking.server.name is the name of the tracking server in networks;

(c) trackingScript is a server-side program that parses and processes the query string after a question mark (?) in the tracking script;

(d) the encoded string after the question mark is the query string in the format of name/value pair. The query string separates different name/value pairs with ampersand (&), and each name/value pair separates name and values with equal signs (=), with the name on the left and the value on the right. In this script, param1=value, param2=value2 and destination=targetURL are three example name/value pairs. The number of name/value pairs is not limited to three. Any number of name/value pairs can be added to the query string. In fact, this kind of tracking script is a typical HTTP request sent to Web server.

A detailed tracking script (2) carried by the broadcasting program is as follows:

http://lennon.hawthorne.ibm.com/servlet/hmTracking?FunctionID=Tracking&Ad ID=30000&Red

Where:

(a) http://lennon.hawthorne.ibm.com/servlet/is the server name and path of servlet directory;

(b) hmTracking is the servlet program (server-side program) designed for interactive TV tracking;

(c) FunctionlD=Tracking is a name/value pair enabling the tracking servlet to work in the tracking mode;

(d) AdID=30000 is a name/value pair identifying the tracked object;

(e) Redirect and its value—The last name/value pair enables the tracking servlet to send back a command to the browser in the set-top box and point it to the following destination URL:

(f) http://lennon.hawthorne.ibm.com/cgi-bin/ncommerce3/ExecMacro/comcast2/tbug.d2w/report%3Fprmenbr%3D9351%

26prrfnbr%3D2368-

The Tracking Flag embodiment can be set in block 209 to “Enable Global Tracking” or “Enable Local Tracking”. These parameters can be carried by the above tracking script (2). If the “Enable Global Tracking” is chosen, a name/value pair “Global=true” will be appended to the tracking script. At this time point, the global tracking will be used for collecting information on the viewer's actions. The collected information will be sent to the global tracking server 107 (See FIG. 1). If the “Enable Local Tracking” is chosen, a name/value pair “Local=true” will be appended to the tracking script. The script itself may also be replaced by a local TV system (e.g. local cable operator) in a token process. A detailed tokenized process is described in related patent application “Method and Apparatus for Content Association Broadcast Data Sources in Enhanced TV”(SOM8-2000-00030), supra. In this embodiment, the corresponding local tracking server 104 (See FIG. 1) will be used to collect information. Of course, both the global tracking server and the local tracking server can be used simultaneously by sending scripting code (e.g. JavaScript) to the client's receiver (e.g. set-top box). Seamless interfacing with multiple local tracking servers is enabled requiring neither change to the tracking server code nor changes to the original audiovisual content from broadcasting station.

The final output formats of interactive TV content creation process are listed in well known data formats, as follows: (a) Data Decision List (DDL), (b) ATVEF (Advanced Television Enhanced Forum), (c) MPEG2 Data Stream, (d) VBI Data Stream and (e) Enhanced Program including audio, video and data stream. In the present embodiment, DDL 219 is used in the tracking information delivery framework.

Thus for every content context, the present invention will enable the individual specification and customizability of information to be efficiently tracked at the time of content creation.

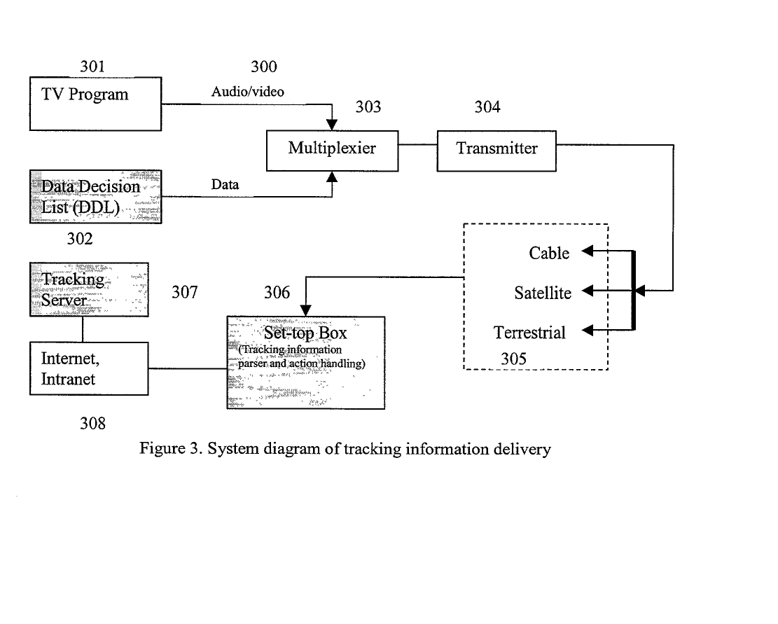

FIG. 3 describes a tracking information delivery system 300. In the tracking information delivery stage, the embedded tracking information can be carried by any broadcast media such as cable network, terrestrial network and satellite network. Further, the tracking information can be delivered either by global broadcast mechanism using direct distribution or by local broadcast replacement mechanism using token-based content association technology, previously described.

In FIG. 3 an interactive TV program 301 carries regular audio/video stream. A Data Decision List (DDL) 302 carries the related interactive action data. A multiplexer 303 is used to combine the regular audiovisual program 301 and the interactive data 302 into one broadcast stream which is modulated by a transmitter 304 for a broadcast network 305.

A receiver 306 may be a Set-top box, digital TV set, PC, or any kind of mobile device that can support HTML or TVTP. In general, the receiver includes a standard tracking information parser which is a program to parse the query string in the tracking script in the data stream and an action handling module is a program to (a) transfer the final parsed URL to an HTML engine or web browser, and (b) calculate how many devices have tuned to the program channel in what kind of modes as well as how many objects in the video program have been tracked. Also the action-handling module automatically appends the device ID (e.g. set-top box ID) to the tracking script.

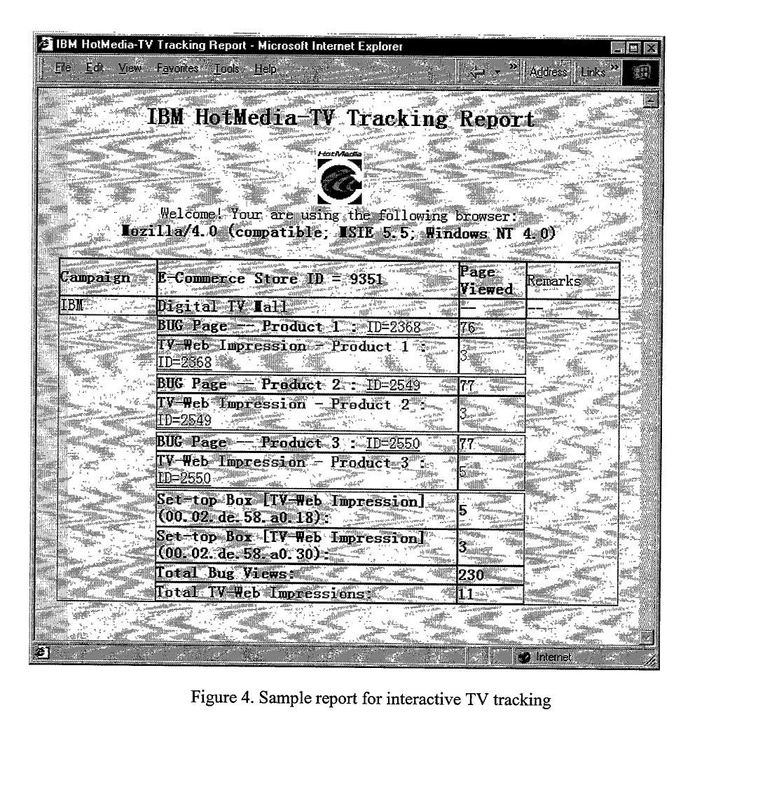

A preferred implementation of the tracking server 307 can implement the following three multilevel tracking patterns (MTP) into consideration: regular program viewing (A TV viewer's viewing mode: only the regular audiovisual program with visible or invisible interactive icon on the video program is on the TV screen), enhanced program viewing (A TV viewer's mode: the regular audiovisual program plus the enhanced interactive content around the audiovisual program are on the same TV screen) and per-object-granularity tracking (A TV viewer's mode: all the hyperlinked objects in the audiovisual program can be clicked by the remote control or mouse). The tracking server redirects the browser or HTML engine to the destination URLs and handles data collecting, analyzing and database management. Also the tracking server can generate real-time tracking report from the database for the Web users by adding the tracking results to a table-based template shown in FIG. 4.

The tracking server will capture a tracking script (3) for each set-top box including a device ID (e.g. uid=00.02.de.58.a0.18). An example tracking script from a set-top box is shown as follows:

http://lennon.hawthome.ibm.com/servlet/hmTracking?FunctionID=Tracking&Ad IED=30000&Red

Where:

(a) The underlined portion is Tracking Script 2 carried by the broadcasting program.

(b) &uid=00.02.de.58.a0.18 is a new name/value pair added by the set-top box to the query string in tracking script (2) based upon viewer inputs or selections of the hyperlinks in the program being viewed.

FIG. 4 shows a web browser based tracking report generated by the tracking server 307 (See FIG.3) for the interactive TV program. The tracking server captures the set-top boxes' IDs for individual experience tracking. In the report, an E-Commerce store (ID=93 51) is used as an example to report viewer interest in the interactive TV program. There are three products in the store. Product 1's ID is 2368. Product 2's ID is 2549. Product's ID is 2550. Each product has a bug page —a small interactive icon shown on the video screen. The interactive icon has a hyperlink to the detailed product information page. If the TV user is very interested in one of the products, he/she may click the icon by using remote control. The clicking action is called TV-Web Impression. Using the interactive TV content creation tool 111 (See FIG. 1), the interactive TV content can implement per-object-granularity-tracking information. Using the preferred tracking server, the following audience information statistics can be obtained: (a) how many set-top boxes have viewed this channel and what kinds of hyperlinked objects?; (b) how many users are interested in the detailed information on the products, etc.?; (c) the number of total set-top boxes means how many people are tuning to this TV channel during a certain time period. The TV-Web Impressions show how many people are enjoying the enhanced TV mode and showing interest in some products, even purchasing these products on the TV screen.

The tracking server can easily count the total number of set-top boxes according to the received tracking scripts including the IDs of the set-top boxes. During a certain time period, once the received tracking script is from a different set-top box, the action-handling module in the tracking server will accumulate the number of the total number of set-top boxes. The hyperlinked objects can be analyzed by the action-handling module in the tracking server according to the values of the AdID and Redirect included in the received tracking scripts. The value of AdID indicates what kind of hyperlinked objects has been selected by a specific TV viewer identified by a device ID. The value of Redirect is the targeting URL visited by the set-top box. If the value of the Redirect is matched with the hyperlink of an Interactive TV icon, then the tracking server will deduce the TV viewer has switched his/her viewing mode from the regular program viewing to the enhanced program viewing for a specific product-buy-opportunity. Based on the viewer switching, the total switching times of the TV viewers is the TV-Web Impressions shown in FIG. 4. Note that these collected tracking information and the calculated values will be saved to a tracking database in real-time.

While the invention has been shown and described in a preferred embodiment various changes can be made without departing from the sprit and scope of the invention as defined in the appended claims, in which:

We claim:

1. A method for real time audience estimation and determination of program and object ratings for interactive TV programs, comprising the steps of:
a) creating interactive TV program in a series of frames incorporating images as objects in the frames;
b) installing hyperlinks in the objects of interest;
c) incorporating a tracking script into the hyperlinks;
d) transmitting the program to a plurality of receivers for display to a viewer;
e) returning to a server the tracking script including a receiver ID based upon a viewer's selection of a hyperlink in an object; and
f) analyzing and determining the program and object ratings.

2. The method of claim 1 further comprising the steps of.
g) selecting an object type for the hyperlinks.

3. The method of claim 1 further comprising the step of
h) linking a hyperlink to a URL, another interactive TV content file, a video clip, an audio clip, an image or a tracking action, and transaction action.

4. The method of claim 1 further comprising the step of:
i) installing the hyperlink types in a tree for viewing and selection by a program creator.

5. The method of claim 1 further comprising the step of
j) assigning linking properties to the hyperlinks in a tracking script.

6. The method of claim 1 further comprising the step of:
k) classifying tracking scripts by URL and other specially defined formats.

7. The method of claim 1 further comprising the step of:
l) selecting the display mode of hyperlinks as visible and/or invisible.

8. The method of claim 1 further comprising the step of:
m) providing multilevel tracking patterns in the hyperlinks, including regular program viewing tracking, enhanced program viewing tracking, and per object granularity tracking.

9. The method of claim 1 further comprising the step of:
n) classifying the hyperlinks by shape, name, description and Z-order.

10. The method of claim 1 wherein the tracking information further comprising the step of:
o) preparing the tracking information in a standard data format.

11. The method of claim 1 further comprising the step of:
p) designating a tracking URL or tracking flag property for the tracking information.

12. The method of claim 1 further comprising the step of:
q) selecting a TV tracking protocol.

13. The method of claim 1 further comprising the step of:
r) assigning a tracking flag property to the tracking information; and
s) selecting “enable global tracking” or “enable local tracking”.

14. A system for real time audience estimation and determination of program and object ratings for interactive TV programs, comprising:
a) content creation apparatus which creates interactive TV program in a series of frames incorporating images as objects in the frames;
b) embedding apparatus which embeds hyperlinks in the objects of interest;
c) installation apparatus which installs tracking information into the hyperlinks;
d) transmitting apparatus which transmits the program with hyperlinks to a plurality of receivers for display to a viewer;
e) receiver apparatus which returns the tracking script including a receiver ID based upon the viewer's selection of a hyperlink in an object; and
f) server apparatus which receives the tracking script.

15. The system of claim 14 further comprises:
g) analyzing apparatus in the server estimating the audience for the program and determining the program and object ratings.

16. The system of claim 14 further comprises:
h) selecting apparatus which selects an object type for the hyperlinks.

17. The system of claim 14 further comprises:
i) linking a hotspot to a URL, another interactive TV content file, a video clip, an audio clip, an image or a tracking action, and transaction action.

18. The system of claim 14 further comprises:
j) installing apparatus which install hyperlink types in a tree for viewing and selection by a program creator.

19. The system of claim 14 further comprises:
k) assigning apparatus which assigns linking properties to the hyperlinks in a tracking script.

20. The system of claim 14 further comprises:
l) classifying apparatus which classifies tracking scripts by URL or other specially defined formats.

21. The system of claim 14 further comprises:
m) display apparatus which selects the display mode of hyperlinks as visible or invisible.

22. The system of claim 14 further comprises:
n) tracking installation apparatus which provides multilevel tracking patterns in the hyperlinks, including regular program viewing tracking, enhanced program viewing tracking, and per object granularity tracking.

23. The system of claim 14 further comprises:
o) classification apparatus which classifies the hyperlinks by shape, name, description and Z-order.

24. The system of claim 14 further comprises:
p) data formatting apparatus which formats the tracking information in a standard data format.

25. The system of claim 14 further comprises:
q) designating apparatus which designates a tracking URL or tracking flag property for the tracking information.

26. The system of claim 14 further comprises:
r) protocol selecting apparatus which selects a TV tracking protocol.

27. The system of claim 14 further comprises:
s) tracking flag apparatus which assigns a tracking flag property to the tracking information and selects between “enable global tracking” or “enable local tracking”.

28. A program medium, executable in a computer system, for real time audience estimation and determination of program and object ratings in interactive TV programs, comprising:
a) program instruction which creates interactive TV program in a series of frames incorporating images as objects in the frames;
b) program instruction which install hyperlinks in the objects of interest;
c) program instructions which incorporate tracking information into the hyperlinks;
d) program instructions which transmit the program to a plurality of receivers for display to a viewer;
e) program instruction which generate a tracking script including a receiver ID based upon a viewer's selection of a hyperlink in an object; and
f) program instructions which transmit the tracking script to a server for audience estimation and determination of the program and object ratings.

29. The medium of claim 28 further comprising:
g) program instructions which select an object type for the hyperlinks.

30. The medium of claim 28 further comprising:
h) program instruction which link a hotspot to a URL, another interactive TV content file, a video clip, an audio clip, an image or a tracking action, and transaction action.

31. The medium of claim 28 further comprising:
i) program instructions which install the hyperlink types in a tree for viewing and selection by a program creator.

31. The medium of claim 28 further comprising:
j) program instructions which assign linking properties to the hyperlinks in a tracking script.

32. The medium of claim 28 further comprising:
k) program instructions which classify tracking scripts by URL and other specially defined formats.

33. The medium of claim 28 further comprising:
l) program instructions which select the display mode of hyperlinks as visible and/or invisible.

34. The medium of claim 28 further comprising:
m) program instructions which provide multilevel tracking patterns in the hyperlinks, including regular program viewing tracking, enhanced program viewing tracking, and per object granularity tracking.

35. The medium of claim 28 further comprising:
n) program instructions which classify the hyperlinks by shape, name, description and Z-order.

36. The medium of claim 28 further comprising:
o) program instructions which prepare the tracking information in a standard data format.

37. The medium of claim 28 further comprising:
p) program instructions which designate a tracking URL or tracking flag property for the tracking information.

38. The medium of claim 28 further comprising:
q) program instructions which select a TV tracking protocol.

39. The medium of claim 28 further comprising:
r) program instructions which assign a flag property to the tracking information; and
s) program instructions which select “enable global tracking” or “enable local tracking”.

40. A server for real time audience estimation and programs ratings for interactive TV programs, comprising:
receiving apparatus which receives tracking scripts from receiver in a TV broadcast system;
tracking apparatus which implement three multilevel tracking patterns;
redirecting apparatus which redirects a browser or HTML engine to a destination URL in the tracking script; and
report generating apparatus which generate real-time tracking report adding receiver tracking script results to a table-based template report.

41. A receiver for interactive TV programs, comprising:
receiving apparatus which receives tracking scripts embedded in an interactive TV program;
parsing apparatus which parses the tracking script;
action enablement apparatus which appends a receiver ID to the tracking script; and
transmitting apparatus which transmit the appended tracking script to a server for real time audience estimation and program ratings of the interactive TV program.
